(19) United States
(12) Patent Application Publication
(10) Pub. No.: US 2026/0287551 A1
(43) Pub. Date: Sep. 24, 2026

(54) THREE-DIMENSIONAL LASER ABLATION MASS SPECTROMETER, COMBINED DETECTION SYSTEM, AND DETECTION METHOD

(71) Applicant: SHANGHAI CHEMLAB INSTRUMENT CO., LTD, Shanghai (CN)

(72) Inventors: Yonggang Hu, Shanghai (CN); Guorong Chen, Shanghai (CN)

(73) Assignee: SHANGHAI CHEMLAB INSTRUMENT CO., LTD, Shanghai (CN)

(21) Appl. No.: 19/475,407

(22) PCT Filed: Mar. 7, 2024
(86) PCT No.: PCT/CN2024/080432

§ 371 Date: Oct. 14, 2025

(30) Foreign Application Priority Data
Jun. 9, 2023 (CN) 202310679935.6

(51) Int. Cl. G01N 27/626; G01N 21/65

(52) U.S. Cl. CPC G01N 27/626; G01N 21/65

(57) ABSTRACT

A three-dimensional laser ablation mass spectrometer, a combined detection system, and a detection method. The three-dimensional laser ablation mass spectrometer comprises a laser ablation system, a detection cell, a grinding and polishing system, and a mass spectrometry detection apparatus. The combined detection system comprises a three-dimensional laser ablation mass spectrometer and a Raman laser system. The detection method comprises: performing detection on a sample and then performing sample surface grinding and polishing on the sample. By means of introducing mechanical grinding and polishing, a thermal change layer generated on a surface of a sample due to laser ablation is removed, the high efficiency of laser ablation is utilized, and a possible effect of energy at a focus point during laser ablation on detection is also eliminated.

### TECHNICAL FIELD

The present invention relates to the technical field of laser ablation, and more particularly to a three-dimensional laser ablation mass spectrometer, combined detection system, and detection method.

### RELATED ART

Raman spectrum analysis is a rapid non-destructive testing technology, and is mainly used for an analysis method for molecular structure research. The laser ablation inductively coupled plasma mass spectrum is a laser ablation as a solid direct injection mode, and is used for sample element analysis by combination with a mass spectrum. Both of these analysis methods have a wide range of applications.

Raman spectra are a scattering spectrum. The Raman spectrum analysis method is a Raman scattering effect found on the basis of an Indian Scientist C. V. Raman, and analyzes the scattered light spectrum different from the incident light frequency to obtain molecular vibration and rotation information, and is applied to an analysis method for molecular structure research.

When a sample is irradiated with monochromatic light having a wavelength smaller than the particle size of the sample, most of the light is transmitted in the original direction, and a small portion is scattered at different angles to generate scattered light. When viewed in the vertical direction, in addition to Rayleigh scattering at the same frequency as the original incident light, there are several very weak Raman spectral lines with a very weak shift (frequency shift increase or decrease) with incident light frequency, and this phenomenon is called Raman effect.

The Raman spectrum is very sensitive to molecular bonding and the structure of the sample, so that each molecule or sample has its unique spectral “fingerprint”. These “fingerprints” can be used to perform research and analysis of chemical identification, morphology and phase,

The Raman spectroscopy technology is rich in information, simple in preparation, small in water interference, and not affected by the morphology of the sample substance, In addition, Raman spectrum analysis has unique advantages such as no damage to the sample, rapid analysis, low maintenance cost, simple use, and the like It has been widely used in the fields of chemistry, materials, physics, high molecules, biology, medicine, geological and the like.

The laser ablation inductively coupled plasma mass spectrum uses a laser to emit a laser beam, uses an objective lens to focus the laser on a specific region, uses the energy of the pulsed laser to directly form tiny particles on the solid sample, forms an aerosol with the carrier gas, and then enters the mass spectrum for elemental detection by means of an inductively coupled plasma source (ICP).

Compared with traditional solution analysis, laser ablation inductively coupled plasma mass spectrometry uses laser ablation solid direct analysis technology to have the characteristics of saving time and labor efficiency, reduces the tedious process of pre-sample treatment, avoids sample pollution caused by introduction of other substances such as strong acids in the pretreatment, and destroys the original state and structure of the sample, and retains information such as the spatial distribution and depth distribution of the sample components.

With the gradual maturation of the laser ablation system, laser ablation is used as a solid direct injection mode, and the combined use of mass spectrometry has great advantages in trace, super trace elements, isotope analysis, etc. and not only plays an important role in the development of the technical development of the Earth Science, but also extends to the fields of material science, environmental science, marine science, life science and the like.

At present, Raman spectrum analysis and laser ablation inductively coupled plasma mass spectrometry are independently present in a laboratory by separate analysis methods, and there are no cases in which both people combine them for application in the market.

The existing elemental analysis is mainly analyzed by X fluorescence, but the detection sensitivity is not high, and the detection element is limited; the other is ICP-MS analysis. However, existing samples are pre-treated, and other substances such as strong acids need to be introduced for digestion, which can cause sample contamination and damage the original state and structure of the sample, and cannot obtain in-situ information of the sample.

The wafer is a basis for modern semiconductors and plays a huge role. The trace impurity elements introduced between the elements in the wafer production process can reduce the yield of the chip; the specific contamination problem can lead to different defects of the semiconductor device, for example, alkali or alkaline earth metals (Li, Na, K, Ca, Mg, Ba, etc.) can lead to a reduction in the breakdown voltage of the element; and the contamination of the transition metal and the heavy metal (Fe, Cr, Ni, Cu, Au, Mn, Pb, etc.) can reduce the service life of the element or increase the dark current during operation of the element.

The existing wafer surface metal contamination detection technology mainly has two types, one type is TXRF detection technology, and a TXRF total reflection fluorescence spectrum detector is used for detection. TXRF test principle: when the X-rays are fully emitted, the intensities of the incident X-rays and the emitted X-rays are equal, the coherent and incoherent scattering phenomena of the primary X-rays on the reflector are eliminated, and the scattering background is reduced by about 3-4 orders of magnitude, thereby greatly improving the peak-to-back ratio. TXRF is an analysis technology that uses the principle of X-ray total reflection to coat a sample into a thin layer (nm stage) on a reflector and sample rack, thereby reducing the scattering background and improving the peak-to-back ratio, so as to realize an analysis technique for trace element analysis. The test wafer sample size is 2-8 inches, and the W target can test the elements: (S, CI, K, Ca, Ti, Cr, Ba, Fe, Ni, Cu, Zn, Pb, Sn), and the Mo target can test the elements: (Br, Au, Ga, As, Pb, Ta, W, Pt), and the W target and the Mo target element cannot be simultaneously detected. There are 3 points at the time of detection, and the special requirements can be increased to 5 points.

Another type of wafer surface metal contamination detection technology is VPD-ICPMS detection, which is a mainstream detection technology for the current wafer factory. VPD: Vapor Phase Decomposition Chemical Weather Decomposition, ICP-MS Full-Load Inductively Coupled Plasma Mass Spectrometry. The technical test wafer has a size of 2 inches to 12 inches. the test process comprises four steps: 1. placing a silicon wafer in a VPD chamber, and exposing the silicon wafer to HF vapor to dissolve a natural oxide or a thermally oxidized SiO2 surface layer; 2. 2% HIF/2% H2 O2, typically 250 μL, are placed on the water and then tilted in a carefully controlled manner such that the droplets “sweep” on the wafer surface; 3, as the extracted droplets move on the wafer surface, it collects dissolved SiO2 and all contaminant metals; 4 transfers the extracted droplets from the wafer surface to the ICP-MS system for analysis.

In summary, the prior art has the following main problems:
1. The Raman spectrum analysis and laser ablation inductively coupled plasma mass spectrometry analysis are all independent tests. If the molecular structure diagram and the elemental map of the sample are obtained at the same time, tests must be performed in different laboratories, respectively; the molecular structure diagram and the element map of the same sample cannot completely match the element map in situ information due to separate independent tests, so that the one-to-one correspondence cannot be presented;
2. pretreating a sample, requiring the introduction of other substances such as strong acids for digestion, which can cause sample contamination and damage the original state and structure of the sample, and cannot obtain in-situ information of the sample;
3. The existing means cannot accurately obtain the in-situ information three-dimensional molecular structure diagram of the sample, especially the Raman spectrum can only detect that the surface layer information of the sample cannot perform three-dimensional imaging on the sample, and the analysis efficiency is very low;
4. The silicon wafer pollution test TXRF detects only some of the elements at one time, and is not able to detect organic pollution. The VPD-ICPMS detects many pretreatment steps before the sample, is relatively complex, introduces other pollutants, causes interference to the analysis, and

When the Raman spectrum analysis and the laser mass spectrometry are directly used for combined imaging, in the process of three-dimensional joint imaging, due to the influence of the energy generated by laser focusing on the material surrounding the focal point, for example, element migration is generated, and a key form change (including a change in the composition of the organic pollutant) is generated, thereby affecting the final imaging result, such that the accuracy and precision of the detection result thereof are lower than expected.

Therefore, how to couple Raman spectrum analysis with laser ablation inductively coupled plasma mass spectrometry and more accurately obtain in-situ information and improve the analysis efficiency is an urgent problem to be solved.

### SUMMARY OF THE INVENTION

In view of the above, one of the objectives of the application is to provide a three-dimensional laser ablation mass spectrometer, comprising: a laser ablation system, the laser ablation system being used for emitting laser ablation laser, and the laser ablation system comprising a three-dimensional galvanometer system; a detection pool, the detection pool comprising a detection pool housing, a stage, a sample door, an air inlet, an air outlet, an ablating laser window and a vacuum pump, the stage being used for holding a sample, the stage being arranged in the detection pool housing, the sample door, the air inlet, the air outlet, and the ablating laser window being provided on the detection pool housing; a grinding and polishing system, the polishing and polishing system being used for grinding a surface of a sample scanned by a laser ablation system;

The mass spectrometry detection device is used for performing mass spectrometry detection on an aerosol generated by a laser ablation system.

Preferably, the three-dimensional laser ablation mass spectrometer, further comprising a wafer manipulator, wherein the wafer manipulator is used for wafer loading and unloading.

Preferably, wherein the laser ablation system further comprises a laser emitter and a field lens, and the laser emitter emits an ablating laser to focus on the surface of the sample;

The three-dimensional galvanometer system comprises a moving lens, a focusing lens, an X-axis galvanometer and a Y-axis galvanometer;

The moving lens can move axially, the moving lens changes the distance between the moving lens and the focusing lens by adjusting the distance between the moving lens and the focusing lens, so that the position of the ablating laser is changed along the Z axis on the surface of the sample;

The X-axis galvanometer and the Y-axis galvanometer can respectively perform high-frequency winding reciprocating rotation, and the X-axis galvanometer and the Y-axis galvanometer are used for adjusting a focusing position in a horizontal direction of the sample surface.

Preferably, wherein the grinding and polishing system comprises a polishing head, a holder, a grinding disk, a motor and a PLC control module, the grinding disk is used for holding a sample, the holder is used for fixing a sample contained in the grinding disk, and the PLC control module is used for controlling the polishing and polishing system.

A combined detection system, comprising: a three-dimensional laser ablation mass spectrometer; a Raman laser system, the Raman laser system being used for emitting Raman detection laser and detecting Raman scattered light; the detection pool is a combined detection pool. The combined detection pool further comprises a Raman laser window. The object stage is a movable stage. The movable stage is further used for switching and positioning a sample between positions corresponding to the Raman laser window and the ablation laser window. The movable stage comprises a grating ruler feedback control system, and the Raman laser window is provided on the detection pool housing.

Preferably, wherein the combined detection pool further comprises a sample observation window, and the sample observation window is used for quickly observing the position of the sample.

A detection method for a three-dimensional laser ablation mass spectrometer, characterized in that the three-dimensional laser ablation mass spectrometer is used, and the sample is a wafer.

Preferably, the detection method, comprising the following steps:
Step S1: placing a sample into the detection pool, fixing a position corresponding to a laser window on the stage, and performing gas replacement on the detection pool by means of a carrier gas;
Step S2: focusing the ablating laser on the surface of a sample to perform a two-dimensional laser ablation-mass spectrometry scanning, wherein the two-dimensional laser ablation-mass spectrometry scanning comprises several laser ablation times and an aerosol generated by laser etching is fed to a mass spectrometry detection device for detection;
Step S3: turning off the carrier gas, and feeding the sample to the polishing and polishing system, wherein the polishing and polishing system automatically performs polishing and cleaning on the surface of the sample after being subjected to erosion, and performs drying at room temperature;
Step S4: repeating steps S1 to S3 until a three-dimensional scan is completed;
Step S5: performing data processing.

A detection method for a combined detection system, characterized in that the combined detection system is used.

Preferably, the detection method, comprising the following steps:
Step S1: placing a sample into the combined detection pool, fixing the sample on the mobile carrier, and performing gas replacement on the combined detection pool by means of a carrier gas;
Step S2: moving the sample to a position corresponding to the Raman laser window by means of the movable stage;
Step S3: focusing the Raman detection laser on the surface of a sample, and performing two-dimensional Raman spectroscopy scanning;
Step S4: moving the sample to a position corresponding to the ablating laser window by means of the movable stage;
Step S5: focusing the ablating laser on the surface of a sample, and performing a two-dimensional laser ablation-mass spectrometry scanning, wherein the two-dimensional laser ablation-mass spectrometry scanning comprises several laser ablation times and an aerosol generated by laser etching is fed to a mass spectrometry detection device for detection;
Step S6: turning off the carrier gas, and feeding the sample to the grinding and polishing system, the grinding and polishing system automatically polishing and cleaning the surface of the sample after being ablated, and blowing dry at room temperature;
Step S7: repeating steps S1 to S6 until a three-dimensional scan is completed;
Step S8: performing data processing.

Preferably, wherein the sample is a wafer or a metal organic framework compound or a novel semiconductor material.

Compared with the prior art, the application has the following beneficial effects:
1) according to the present application, by introducing mechanical polishing, the thermal variable layer generated by laser ablation on the surface of the sample is removed, and on the one hand, the high-efficiency of laser ablation is used, and on the other hand, the influence of energy on the focal point of laser ablation on detection may be eliminated;
2) the present application can be applied to the online automatic detection of a silicon wafer, can detect the organic pollution and elemental contamination of the wafer, and can meet the characteristics of real-time rapid on-line detection of the surface particles and the entire pollution component of the integrated circuit production link without pre-treating the sample, and does not cause secondary pollution or damage to the silicon wafer;
3) the combined detection method of the present application can simultaneously obtain an in-situ information three-dimensional molecular structure diagram and a three-dimensional element imaging diagram of a sample strip, and the three-dimensional can present a corresponding relationship on the in-situ information; When the sample is detected, the laser ablation system is used for acquiring the aerosol required for mass spectrometry detection on the one hand, and on the other hand, the surface layer erosion effect is also achieved, so that the Raman laser system can detect structural information of the interior below the surface layer of the sample, and on the one hand, the influence of element migration on the mass spectrum in the heat-change layer is avoided, and on the other hand, the influence of the chemical structure with poor heat resistance in the heat-change layer on the Raman spectrum is also avoided; Moreover, since the scanning speed of the laser etching system is greatly accelerated, the Raman laser system-laser etching system is not required to perform confocal focusing, thereby simplifying the device.

### DESCRIPTION OF THE DRAWINGS

In order to more clearly illustrate the technical solutions in the embodiments of the present invention or in the prior art, a brief introduction to the drawings necessary for describing the embodiments or the prior art is provided below. It is apparent that the drawings in the following description are merely some embodiments of the present invention, and for those of ordinary skill in the art, other drawings can be obtained based on these drawings without inventive effort.

FIG. 1 is a schematic structural diagram of a first embodiment of the present application;

FIG. 2 is a schematic structural diagram of a three-dimensional galvanometer system according to Embodiment 1 of the present application;

FIG. 3 is a schematic flowchart of a detection method according to Embodiment 1 of the present application;

FIG. 4 is a schematic structural diagram of a second embodiment of the present application;

FIG. 5 is a schematic structural diagram of a combined detection tank according to a second embodiment of the present application;

FIG. 6 is a schematic flowchart of a combined detection method according to Embodiment 2 of the present application;

Wherein: 101. Raman detection laser transmitter; 102. interference filter; 103. power attenuation sheet; 104 light source polarizer; 105. a light source reflector; 106. Rayleigh filter; 107. a microscope system; 108 confocal pinhole; 109 slits; 110. grating; 111 detector; 112 detecting polarizer; 113 detecting mirror; 201 ablating laser emitter; 202 three-dimensional galvanometer system; 2021 moving lens; 2022 focusing lens; 2023 X-axis galvanometer; 2024 Y-axis galvanometer; 203-field mirror; 300 detection tank; 301 sample; 302 carrier gas; 303 sample cup; 304 stage; 305 aerosol; 401 grinding head; 402 gripper; 403 water nozzle; 404 grinding disk; 405 motor; 406 PLC control module.

### DETAILED DESCRIPTION OF EMBODIMENTS

One of the cores of the present application is a three-dimensional laser ablation mass spectrometer, a combined detection system and a detection method. By introducing mechanical polishing, a thermal variable layer generated by laser ablation on the surface of a sample is removed. On the one hand, the high-efficiency of laser ablation is used, and on the other hand, the influence of energy of a focal point of laser ablation on detection may be eliminated.

The technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

### Embodiment 1

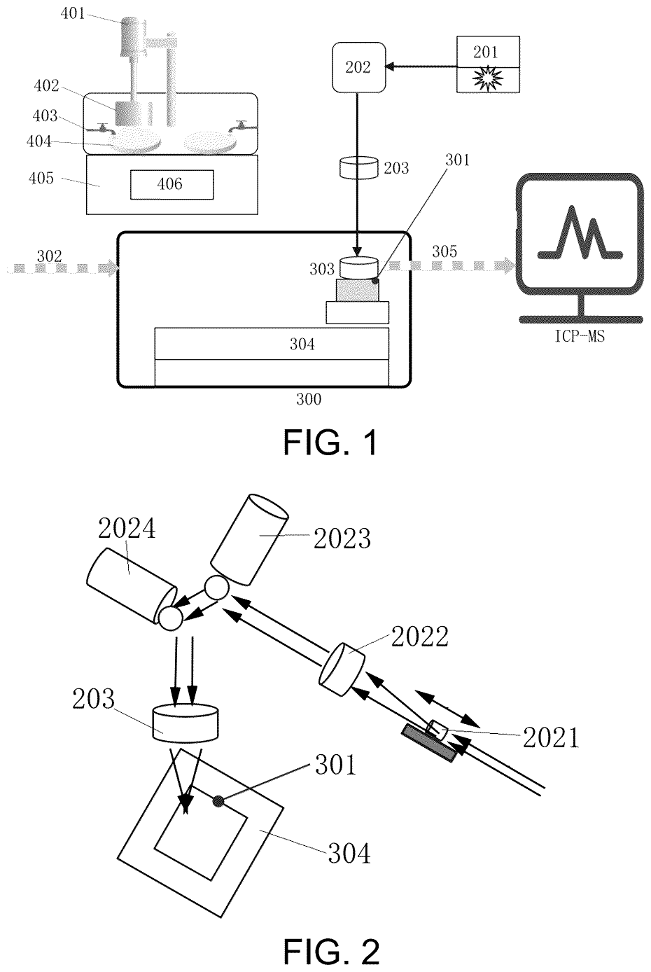

Referring first to FIG. 1, the three-dimensional laser ablation mass spectrometer of the present embodiment comprises a fully automatic grinding and polishing system. Laser etching system, detection tank and mass spectrum detection device the laser ablation system is used for emitting laser ablation laser, and the laser ablation system comprises a three-dimensional galvanometer system; the fully automatic grinding and polishing system is used for grinding the surface of the sample scanned by the laser ablation system; and the mass spectrometry detection device is used for performing mass spectrometry detection on the aerosol generated by the laser etching system. In addition, the present embodiment further comprises a wafer manipulator (not shown in the FIG.), and the wafer manipulator is used for loading and unloading the wafer.

As shown in FIG. 1, the fully automatic grinding and polishing system comprises a grinding head 401, a gripper 402, a water nozzle 403, a grinding disk 404, a motor 405 and a PLC control module 406, wherein the grinding head 401 is used for grinding and polishing a sample, the grinding disk 404 is used for holding a sample, the gripper 402 is used for fixing a sample contained in the grinding disk 404, the water spray nozzle 403 is used for cleaning the polished sample, the motor 405 is used for driving the aforementioned components, and the PLC control module 406 is used for controlling the operation of the components of the fully automatic grinding and polishing system.

As shown in FIG. 2, the three-dimensional galvanometer system 202 comprises a moving lens 2021, a focusing lens 2022, an X-axis galvanometer 2023 and a Y-axis galvanometer 2024; The moving lens 2021 can move axially, and the moving lens 2021 changes the distance between the moving lens 2021 and the focusing lens 2022, so that the position of the ablating laser focusing changes along the Z axis on the surface of the sample 301; the X-axis galvanometer 2023 and the Y-axis galvanometer 2024 can respectively perform high-frequency winding reciprocating rotation, and the X-axis galvanometer 2023 and the Y-axis galvanometer 2024 are used for adjusting the focusing position in the horizontal direction of the surface of the sample 301.

The detection tank 300 comprises a detection tank housing, a stage 304, a sample door, an air inlet, an air outlet, an ablating laser window, and a vacuum pump.

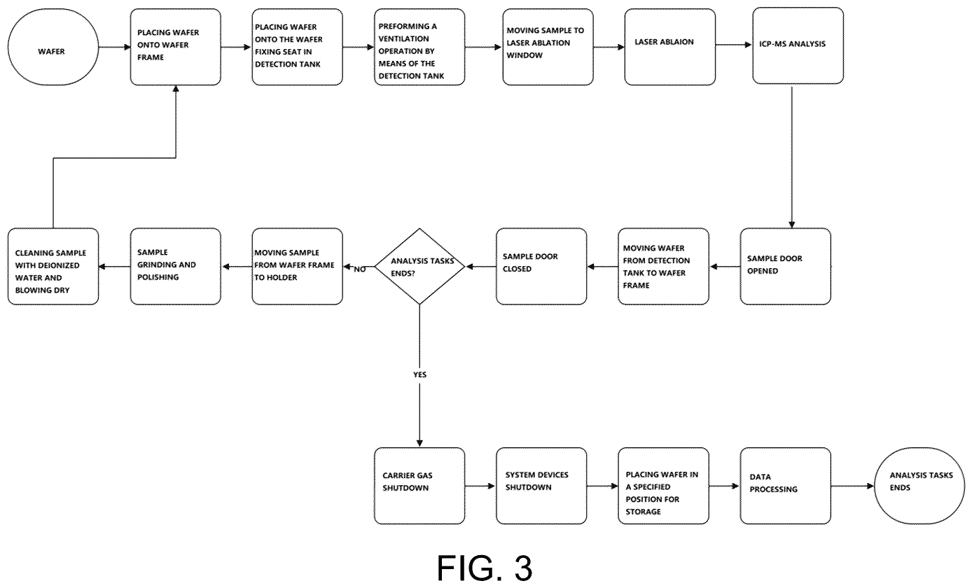

The present embodiment further discloses a detection method using the three-dimensional laser ablation mass spectrometer, as shown in FIG. 3:
1. placing a wafer on a wafer frame;
2. a computer issuing an instruction, opening the sample door by means of the PLC control module, and controlling the wafer manipulator to move the wafer sheet from the wafer frame to the wafer fixing seat in the sample cell;
3. the sample door is closed and sealed;
4. performing a ventilation operation by means of the detection tank; the vacuum pump automatically opening the vacuumizing, and after the vacuum degree is set, stopping the vacuumizing and introducing the carrier gas; after the pressure of the detection tank reaches a set value, the vacuum pump automatically opening the vacuumizing, and after the vacuum degree is set, stopping the vacuumizing, introducing the carrier gas, so as to perform reciprocating three times;
5. the computer automatically and precisely adjusts the mobile station to achieve laser focusing on the wafer. The microscope system is equipped with a high-resolution color camera, and the storage image is automatically photographed. the computer precisely controls the three-dimensional movement of a sample to be tested, the laser ablation system starts to work, and operates according to preset relevant operating parameters (the frequency, energy density, spot size, carrier gas flow rate, and X, Y, and Z coordinate parameters, etc.) of the laser, the laser module generates a laser beam, the X-axis and the Y-axis deflect at a high speed, the laser beam enters the field lens and is focused onto the working surface, the “Z” axis is automatically and accurately focused, and the three-dimensional laser ablation of the sample is performed;
6. a laser ablation sample directly forms tiny particles, forms an aerosol with a carrier gas, and then plasma is plasma-formed by means of an inductively coupled plasma source (ICP), and then enters a mass spectrum for elemental detection to form a high-quality element plan view of the sample.
7. After laser ablation is completed, the sample door is automatically opened, the carrier gas is closed, the wafer manipulator moves the wafer onto the wafer frame of the detection tank, and the sample compartment door is automatically closed;
8. an wafer manipulator removing the wafer from the wafer frame, and placing the wafer into a fully automatic polishing system holder for fixing;
9. automatically grinding and cleaning a wafer sheet by a fully automatic grinding and polishing system, and blowing dry at room temperature;
10. after polishing is completed, the wafer manipulator moving the wafer onto the wafer frame;
11. repeating steps 2-10 in the method until the analysis task ends;
12, taking out the wafer sample, placing same into a sample box, performing a mark, and placing same in a specified position for storage;
13. shutdown of carrier gas and system devices according to standard procedures
14. a computer system automatically processes data and gives a three-dimensional elemental imaging diagram of in-situ information of the sample.

Compared with traditional mechanical polishing, laser ablation scanning can remove a sample layer having a characteristic thickness more quickly; however, due to energy focusing at the laser focusing point, a thermal effect is provided to cause the ablated surface to generate a heat variable region (i.e. a thermal variable layer is formed after one layer of two-dimensional erosion scanning is completed), and the material in the region forms a certain change in a bonding manner. For a wafer having a high detection precision requirement, a doping element may also undergo surface migration or lateral migration, and therefore, interference can be caused to a detection result. In the present embodiment, the thermal variable layer on the surface is removed by means of mechanical grinding, so as to eliminate the influence thereof, and the thickness of the thermal variable layer itself is extremely small, so that the treatment efficiency for polishing same is high.

In some other applications, those skilled in the art can also scan only a specified depth or depth interval, and can perform grinding and polishing on the surface after the previous depth jumps from the previous depth to the next depth.

### Embodiment 2

This embodiment differs from Embodiment 1 in that an additional Raman laser system, a Raman laser system, and a laser ablation system are added to share the same detection tank 300, that is, a combined detection tank.

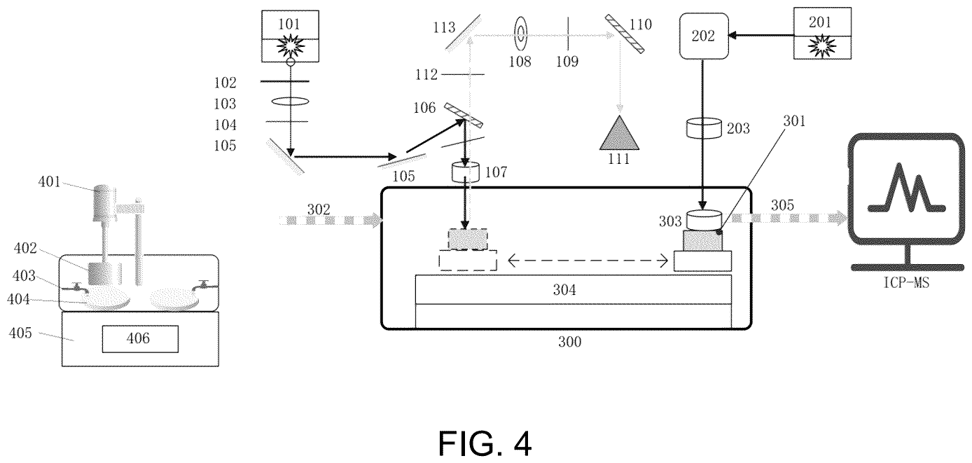

As shown in FIG. 4, the Raman laser system of the present embodiment is a laser confocal microscopic Raman spectrometer, and the laser confocal microscopic Raman spectrometer comprises: a Raman detection laser transmitter 101, an interference filter 102, a power attenuation sheet 103, a polarizer, a reflector, a Rayleigh filter 106, a microscope system 107, a confocal pinhole 108, a slit 109, a grating 110 and a detector 111, wherein the polarizer comprises a light source polarizer 104 and a detection polarizer 112, and the reflector comprises a light source reflector 105 and a detection reflector 113; the laser ablation system comprises a three-dimensional galvanometer system, an ablating laser emitter 201 and a field lens 203; etching the laser emitter 201 to emit ablative laser to focus on the surface of the sample 301; the laser beam emitted by the Raman detection laser emitter 101 is focused on the surface of the sample 301 by means of a first optical path, the Raman detection laser emitter 101, the interference filter 102, the power attenuation plate 103, the light source polarizer 104, the light source reflector 105 and the Rayleigh filter 106 are arranged on the first light path; The Raman scattered light generated on the surface of the sample 301 enters the detector 111, the Rayleigh filter 106, the detection polarizer 112, the detection mirror 113, the confocal pinhole 108, the slit 109, the grating 110 and the detector 111 on the second optical path through the second optical path; the first optical path and the second optical path share the microscope system 107, the laser beam is reflected on the Rayleigh filter 106 by means of the first optical path, and the Raman scattered light passes through the Rayleigh filter 106 through the second optical path.

Since the laser ablation system of the present embodiment uses the three-dimensional galvanometer system 202 that can switch the focus position at a high speed, the speed of laser ablation of the two-dimensional scanning is greatly accelerated. Therefore, the detection strategy can also be converted from the strategy of the Raman single-point detection-mass spectrometry single-point detection-switching detection point to the Raman two-dimensional scanning-switching detection window-mass spectrometry two-dimensional scanning strategy, greatly simplifying the difficulty of confocal.

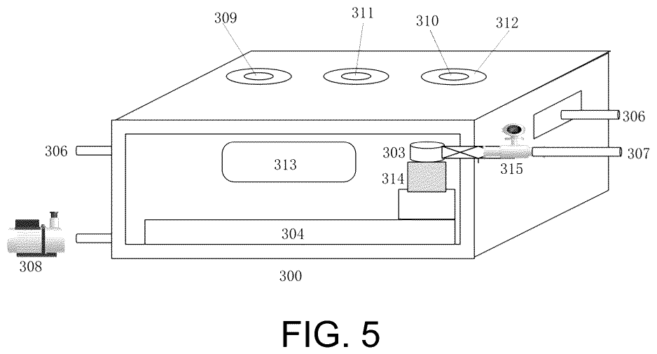

As shown in FIG. 5, the detection tank 300 comprises a detection tank housing, a stage 304, a sample door 313, an air inlet 306, an air outlet 307, a Raman laser window 309, an ablating laser window 310 and a vacuum pump 308; the stage 304 is a movable stage, and the sample 301 can be switched and positioned between the Raman laser window 309 and the position corresponding to the laser window 310; the stage 304 further comprises a grating ruler feedback control system; the detector housing is a sealed housing, the stage 304 is provided in the detection tank housing, the sample door 313, the air inlet 306, the air outlet 307, the Raman laser window 309, and the ablating laser window 310 are provided on the detection tank housing. In a preferred embodiment, a sample observation window 311 can also be provided on the detection tank housing for quickly observing the position of the sample.

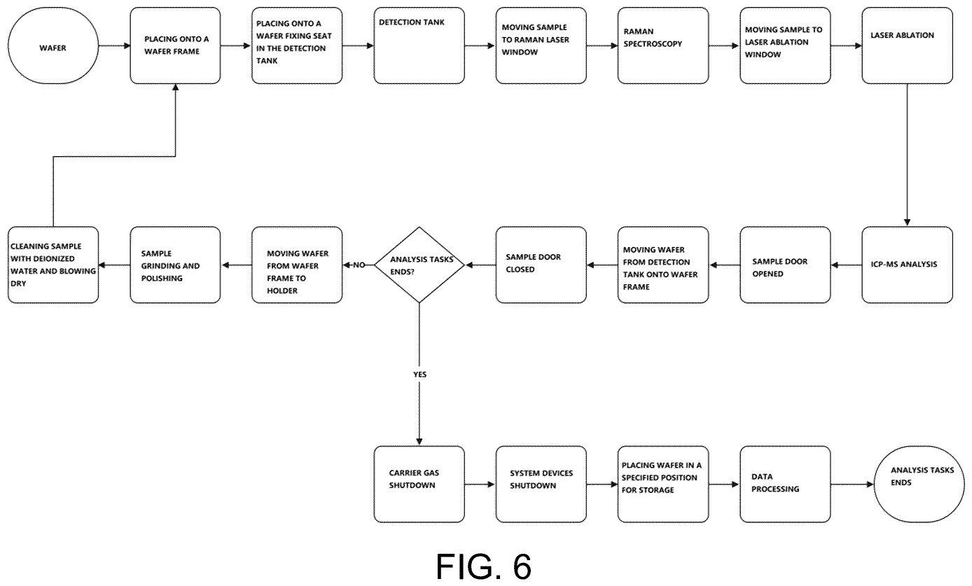

The present embodiment further discloses a detection method using the combined detection system, as shown in FIG. 6:
1. placing a wafer on a wafer frame;
2. a computer issuing an instruction, opening the sample door by means of the PLC control module, and controlling the wafer manipulator to move the wafer sheet from the wafer frame to the wafer fixing seat in the sample cell;
3. the sample door is closed and sealed;
4. performing a ventilation operation by means of the detection tank; the vacuum pump automatically opening the vacuumizing, and after the vacuum degree is set, stopping the vacuumizing and introducing the carrier gas; after the pressure of the detection tank reaches a set value, the vacuum pump automatically opening the vacuumizing, and after the vacuum degree is set, stopping the vacuumizing, introducing the carrier gas, so as to perform reciprocating three times;
5. after the ventilation is completed, moving the wafer stage to the position of the Raman laser window 309;
6. the computer automatically and precisely adjusts the mobile station to achieve laser focusing on the wafer. At the same time, the microscope system is equipped with a high-resolution color camera, and the storage image can be displayed on a computer. precisely controlling, by means of a computer, the object stage 304 to move so that the sample to be tested performs high-precision three-dimensional movement, and selecting a sample micro-area for emitting Raman scattered light, wherein the Raman detection laser emitted by the laser emitter is purified by means of a monochromator and then is accurately focused on the sample by means of an objective lens; the Raman scattered light emitted by the sample is accurately imaged on the incident slit of the monochromator through the condenser lens, and enters the detector by means of grating light splitting and then enters the detector for detection, so as to obtain comprehensive information of the specific range intensity of the Raman signal, and can indicate high-resolution images of related information such as surface substance composition and content distribution;
7. after Raman imaging, controlling the stage 304 to move to an ablating laser window;
8. the laser ablation system starts to work, and operates according to preset relevant operating parameters (the frequency, energy density, spot size and carrier gas flow rate and X, Y, and Z coordinate parameters of the laser); the laser module generates a laser beam, the X-axis and the Y-axis deflect at a high speed, the laser beam enters the field lens and is focused onto the working surface, the “Z” axis is automatically and accurately focused, and the three-dimensional laser ablation of the sample is performed;
9. the laser ablation sample directly forms tiny particles, and forms an aerosol with the carrier gas, and then plasma is plasma-formed by means of an inductively coupled plasma source (ICP), and then enters a mass spectrum for elemental detection to form a high-quality element plan view of the sample.
10. after laser ablation is completed, the sample door is automatically opened, the carrier gas is closed, the wafer manipulator moves the wafer onto the wafer frame of the detection tank, and the sample compartment door is automatically closed;
11. the wafer manipulator removing the wafer from the wafer frame, and placing same into a fully automatic polishing system gripper for fixing;
12. automatically grinding and cleaning a wafer sheet by a fully automatic grinding and polishing system, and blowing dry at room temperature;
13. after polishing is completed, the wafer manipulator moving the wafer onto the wafer frame;
14. repeating steps 2-13 in the method until the analysis task ends;
15. taking out the wafer sample, placing same into a sample box, performing a mark, and placing same in a specified position for storage;
16. closing a carrier gas and a system apparatus according to a standard program;
17. the computer system automatically processes the data and gives a three-dimensional Raman spectrogram and a three-dimensional elemental imaging diagram of the sample with in-situ information, and the sample has the same position three-dimensional Raman spectrum (molecular structure).

In some other applications, those skilled in the art can also scan only a specified depth or depth interval, and can perform grinding and polishing on the surface after the previous depth jumps from the previous depth to the next depth.

In this embodiment, since Raman spectrum detection is a surface detection technology with relatively small detection depth, in combination with laser ablation mass spectrometry, deep detection and scanning inside the sample can be completed by means of etching to remove the surface of the sample.

For a wafer sample, the present embodiment may further obtain related information such as a key structure of the wafer sample by using a Raman spectrum; in some other embodiments, if only the surface of the wafer sample needs to be detected, for example, detecting surface contamination, there is no need to perform grinding, and control information can be obtained only after one Raman detection and one laser ablation.

In addition to the wafer-type sample, for some structures, a solid sample, such as a metal-organic framework compound (MOFs) having a low thermal tolerance, is included in some structures, and the surface chemical structure thereof May also change due to the energy of the focusing point when subjected to laser ablation. Therefore, the mechanical grinding of the present embodiment can also avoid the interference of the above-mentioned heat-change effect on the detection result. In addition, if the sample is made to the same specification as the wafer, the present application can be compatible with a wafer-related handling device simplified process. For a solid sample of a biological sample and a molecular crystal, since the intermolecular force thereof can absorb the energy focused by the laser, there is generally no need to grind.

The embodiments in the present specification are described in a progressive manner, each embodiment focuses on the differences from other embodiments, and the same and similar parts between the various embodiments can be referred to each other.

The above description of the disclosed embodiments enables those skilled in the art to implement or use the present application. Various modifications to these embodiments will be readily apparent to those skilled in the art, and the general principles defined herein May be implemented in other embodiments without departing from the spirit or scope of the present application. Thus, the present application is not to be limited to the embodiments shown herein, but is to be accorded the widest scope consistent with the principles and novel features disclosed herein.

1. A three-dimensional laser ablation mass spectrometer, comprising:
a laser ablation system, the laser ablation system being used for emitting laser ablation laser, and the laser ablation system comprising a three-dimensional galvanometer system;
a detection pool, the detection pool comprising a detection pool housing, a stage, a sample door, an air inlet, an air outlet, an ablating laser window and a vacuum pump, the stage being used for holding a sample, the stage being arranged in the detection pool housing, the sample door, the air inlet, the air outlet, and the ablating laser window being provided on the detection pool housing;
a grinding and polishing system, the polishing and polishing system being used for grinding a surface of a sample scanned by a laser ablation system;
the mass spectrometry detection device is used for performing mass spectrometry detection on an aerosol generated by a laser ablation system.

2. The three-dimensional laser ablation mass spectrometer of claim 1, wherein further comprising a wafer manipulator, wherein the wafer manipulator is used for wafer loading and unloading.

3. The three-dimensional laser ablation mass spectrometer of claim 1, wherein the laser ablation system further comprises a laser emitter and a field lens, and the laser emitter emits an ablating laser to focus on the surface of the sample;
the three-dimensional galvanometer system comprises a moving lens, a focusing lens, an X-axis galvanometer and a Y-axis galvanometer;
the moving lens can move axially, the moving lens changes the distance between the moving lens and the focusing lens by adjusting the distance between the moving lens and the focusing lens, so that the position of the ablating laser is changed along the Z axis on the surface of the sample;
the X-axis galvanometer and the Y-axis galvanometer can respectively perform high-frequency winding reciprocating rotation, and the X-axis galvanometer and the Y-axis galvanometer are used for adjusting a focusing position in a horizontal direction of the sample surface.

4. The three-dimensional laser ablation mass spectrometer of claim 1, wherein the grinding and polishing system comprises a polishing head, a holder, a grinding disk, a motor and a PLC control module, the grinding disk is used for holding a sample, the holder is used for fixing a sample contained in the grinding disk, and the PLC control module is used for controlling the polishing and polishing system.

5. A combined detection system, wherein comprising: a three-dimensional laser ablation mass spectrometer according to claim 1; a Raman laser system, the Raman laser system being used for emitting Raman detection laser and detecting Raman scattered light;
the detection pool is a combined detection pool, the combined detection pool further comprises a Raman laser window, the object stage is a movable stage, the movable stage is further used for switching and positioning a sample between positions corresponding to the Raman laser window and the ablation laser window, the movable stage comprises a grating ruler feedback control system, and the Raman laser window is provided on the detection pool housing.

6. The combined detection system of claim 5, wherein the combined detection pool further comprises a sample observation window, and the sample observation window is used for quickly observing the position of the sample.

7. A detection method for a three-dimensional laser ablation mass spectrometer, wherein the three-dimensional laser ablation mass spectrometer according to claim 1 is used, and the sample is a wafer.

8. The detection method of claim 7, wherein comprising the following steps:
step S1: placing a sample into the detection pool, fixing a position corresponding to a laser window on the stage, and performing gas replacement on the detection pool by means of a carrier gas;
step S2: focusing the ablating laser on the surface of a sample to perform a two-dimensional laser ablation-mass spectrometry scanning, wherein the two-dimensional laser ablation-mass spectrometry scanning comprises several laser ablation times and an aerosol generated by laser etching is fed to a mass spectrometry detection device for detection;
step S3: turning off the carrier gas, and feeding the sample to the polishing and polishing system, wherein the polishing and polishing system automatically performs polishing and cleaning on the surface of the sample after being subjected to erosion, and performs drying at room temperature;
step S4: repeating steps S1 to S3 until a three-dimensional scan is completed;
step S5: performing data processing.

9. A detection method for a combined detection system, wherein the combined detection system according to claim 5 is used.

10. The detection method of claim 9, that, wherein comprising the following steps:
step S1: placing a sample into the combined detection pool, fixing the sample on the mobile carrier, and performing gas replacement on the combined detection pool by means of a carrier gas;
step S2: moving the sample to a position corresponding to the Raman laser window by means of the movable stage;
step S3: focusing the Raman detection laser on the surface of a sample, and performing two-dimensional Raman spectroscopy scanning;
step S4: moving the sample to a position corresponding to the ablating laser window by means of the movable stage;
step S5: focusing the ablating laser on the surface of a sample, and performing a two-dimensional laser ablation-mass spectrometry scanning, wherein the two-dimensional laser ablation-mass spectrometry scanning comprises several laser ablation times and an aerosol generated by laser etching is fed to a mass spectrometry detection device for detection;
step S6: turning off the carrier gas, and feeding the sample to the grinding and polishing system, the grinding and polishing system automatically polishing and cleaning the surface of the sample after being ablated, and blowing dry at room temperature;
step S7: repeating steps S1 to S6 until a three-dimensional scan is completed;
step S8: performing data processing.

11. The detection method of claim 9, wherein the sample is a wafer or a metal organic framework compound or a novel semiconductor material.
